(19) United States
(12) Patent Application Publication
(10) Pub. No.: US 2013/0117278 A1
(43) Pub. Date: May 9, 2013

(54) METHODS, COMPUTER-ACCESSIBLE MEDIUM AND SYSTEMS FOR CONSTRUCTION OF AND INTERFERENCE WITH NETWORKED DATA, FOR EXAMPLE, IN A FINANCIAL SETTING

(71) Applicants: David Martens, Berohem (BE); Foster Provost, New York, NY (US)

(72) Inventors: David Martens, Berohem (BE); Foster Provost, New York, NY (US)

(21) Appl. No.: 13/634,404

(22) PCT Filed: Mar. 11, 2011
(86) PCT No.: PCT/US11/28175

§ 371 Date: Jan. 11, 2013

Related U.S. Application Data
(60) Provisional application No. 61/313,601, filed on Mar. 12, 2010.

(51) Int. Cl. G06F 17/30

(52) U.S. Cl. CPC G06F 17/30595
USPC 707/748; 707/758

(57) ABSTRACT

Networked data can, e.g., define connections between similar entities. Such data can be valuable for, e.g., improving business revenue opportunities (e.g., increasing sales, reducing customer attrition/churn, etc.) as networked data can capture similarities that can be often hard to encapsulate in traditional variables such as, e.g., socio-demographics. For example, related research has generally focused on the case where social network data was obtained directly or indirectly from online data, or from offline call logs in a telecommunication setting. Results can be implemented when inferring the values of target variables over the networked data. Methods, computer-accessible medium and systems according to exemplary embodiments of the present disclosure for creating privacy-friendly pseudo-social networked (PSN) data from off-line banking data can be provided. Exemplary PSN in accordance with certain exemplary embodiments of the present disclosure can be used, e.g., for a variety of networked data-mining applications for banks and other financial institutions to increase revenue or manage risk, for example.

### CROSS-REFERENCE TO PRIOR APPLICATIONS

This application claims priority from U.S. Provisional Application Ser. No. 61/313,601 filed on Mar. 12, 2010, the disclosure of which is incorporated by reference herein in its entirety.

### FIELD OF THE DISCLOSURE

The present disclosure relates to and describes exemplary embodiments of methods, computer-accessible medium and systems for construction of and inference with networked data, for example, in a financial setting such as a bank setting and more particularly to exemplary embodiments of methods, computer-accessible medium and systems for generating privacy-friendly pseudo-social networked (PSN) data from off-line banking data.

### BACKGROUND INFORMATION

Networked data typically defines connections between similar entities. Such data can be valuable for improving business revenue opportunities (e.g., increasing sales, reducing customer attrition/churn, etc.), as networked data is able to capture similarities that are often hard to encapsulate in traditional variables such as socio-demographics. Hence, whenever person X bought some product, and is tied to person Y, assuming they have similar characteristics, person Y is also likely to buy such a product. Targeting network neighbors of current customers can therefore be an efficient marketing strategy.

The use of networked data for marketing purposes has been applied, for example, for direct marketing, churn prediction and brand advertising. Reported results have generally been very good, with what can be considered a significant improvement in comparison to traditional approaches. For example, Hill et al. (Hill, S., Provost, F., Volinsky, C., Network-based marketing: Identifying likely adopters via consumer networks, Statistical Science 22, 256-276, 2006 —the “Hill Publication”) use networked data in a telecommunication setting and report a service adoption among the network neighbors that can be approximately 3 to 5 times higher, compared to non-network neighbors, even among consumers selected based on best practices by a marketing group, including what can be considered to be sophisticated targeting models.

Related research has generally focused on social networks, where someone can start from an idea that social relationships can tend to be made between people with similar characteristics, which is a concept that can be called homophily (See, e.g., McPherson, et al., Birds of a feather: Homophily in social networks, Annual Review of Sociology 27 (1), 415-444, 2001).

Previously, the use of networked data to provide improved business revenue opportunities have generally been limited to the cases where an explicit social or inferred quasi-social network is available. The latter type of cases (inferred quasi-social network being available), for example, can be done in online settings, using visitations to social network websites or other user-generated content sites (see, e.g., Provost, et al., Audience selection for on-line brand advertising: privacy-friendly social network targeting, In: KDD '09: Proceedings of the 15th ACM SIGKDD International Conference on Knowledge Discovery and Data Mining. ACM, New York, N.Y., USA, pp. 707-716, 2009). The offline case has been generally limited to the telecom (telecommunications) sector, where communication records typically directly respond to a social network (see, e.g. Dasgupta, et al., Social ties and their relevance to churn in mobile telecom networks, In: EDBT '08: Proceedings of the 11th international conference on Extending database technology. ACM, New York, N.Y., USA, pp. 668-677, 2008; and Hill Publication, supra.).

Richardson and Domingos publication, described herein. can be considered as having used, e.g., data from knowledge sharing site Epinions, where products can be reviewed. Users can list reviewers that they trust, which can define the social network. An assumption can be that a user can be more likely to purchase a product if it was reviewed by a person that the user trusts, for example. Viral marketing can be considered as having resulted in a considerable increase in profit over direct marketing, for example. Aral, S., Muchnik, L., Sundararajan, A., Distinguishing influence-based contagion from homophily-driven diffusion in dynamic networks, Proceedings of the National Academy of Sciences 106 (51), 21544-21549, 2009 can be considered as using daily instant messaging (IM) traffic among approximately 27.4 million users of Yahoo.com to define a social network. Results can show that adopters can have a 5-fold higher percentage of adopters in their local networks, for example.

Provost et al. publication (the “Provost Document”), also described herein. can use a bi-partite graph to link browsers to user generated content (UGC) sites, such as blogs and social network sites. By linking browsers that can observe the same UGC site, a network data graph among browsers can be constructed in a privacy-friendly manner. The strength of the links can be based on, e.g., the frequency of the visits. They can show that this quasi-social network can embed a true social network. There are several differences however between this work and the exemplary methods and systems disclosed and described herein, including the description of the Provost et al. publication that, e.g.,
a. Provost Document can be considered as having been designed and tailored to improve on-line advertising.
b. Provost Document can also be considered as being based on online content visitations. In contrast, exemplary embodiments of the methods and systems described herein can, e.g., connect consumers indirectly through funds transfers-to common third parties, or among each other (the latter more frequent outside the United States). This can be an important difference that, e.g., can allow exemplary embodiments according to the present disclosure to create networked data from which leverage can be obtained for, e.g., banking and/or financial applications.
c. In accordance with the Provost Document, the on-line advertising bi-partite graph can have only outgoing edges from the browsers (browsers to UGC sites), while in accordance with exemplary embodiments of the present disclosure, there can be, e.g., both incoming and outgoing edges to and from the customers, which can, e.g., provide for richer network prediction techniques, for example.
4. The Provost Document describes that the network that can be inferred can be termed a quasi-social network as it can embed a true social network. In contrast, according to another exemplary embodiment of the present disclosure, a network that can be inferred would likely not embed a true social network to a significant extent (what can be called, e.g., a pseudo-social network), but can still link similar customers.
5. As described above, in accordance with the Provost Document, the bi-partite graph can link browsers to one type of entity, e.g., web pages. In contrast, according to exemplary embodiments of the present disclosure, e.g., it is possible to link various customers with a variety of exemplary products and services, which can be from different locations and in different amounts, as well as payment originators, for example.

Some examples of prior recommender systems can make personalized recommendations to individual customers, based on, e.g., product-based data, customer-based data and previous interactions between customers and products (Adomavicius, G., Tuzhilin, A., Toward the next generation of recommender systems: A survey of the state-of-the-art and possible extensions, IEEE Transactions on Knowledge and Data Engineering 17, 6, 734-749, 2005; and also see examples in U.S. Pat. No. 6,236,978. Collaborative filtering can be considered to be the most commonly used successful recommender system and can use the interaction data. Zheng, R., Provost, F., Ghose, A., Social network collaborative filtering. Tech. Rep. CeDER-8-08, Center for Digital Economy Research, Stern School of Business, New York University, 2008) can use social network data, by, e.g., taking the weighted average of the ratings from a subset of friends who can have also rated the predicting item.

Huang, Z. et al, Analyzing consumer-product graphs: Empirical findings and applications in recommender systems, Management Science 53 (7), 1146-1164, 2007, describes a use the bipartite consumer-product graphs to, e.g., make recommendations, and use graph concepts as, e.g., the average degree, average path length, and clustering coefficient. The data can be provided from an online Taiwan-based bookstore and an online US-based company in the apparel industry. According, the task at hand can be very different from that of exemplary embodiments according to the present disclosure. For example, rather than recommending from the items, exemplary embodiments according to the present disclosure can use the network data for, e.g., feature creation, and use a separate labeling as the target variable (such as, e.g., churn or response to direct marketing). According to these other systems, the data can inherently come from an online source as well. Thus, it can be believed that no other approach can be considered substantially similar to the exemplary methods and systems disclosed and described herein, for example.

Using large-scale offline network data to improve business revenue opportunities has been limited so far to the telecom industry, as the communication logs define an explicit social network.

The Hill Publication described herein describes the use networked data for, e.g., direct marketing using data from a large telecom operator, aiming for customers who can be likely to adopt a new communication service. It can be presumed that someone who has direct communication with a current subscriber can be, e.g., more likely to adopt the service, and that the network neighbors can be targeted. For example, it can be shown that network neighbors (e.g., those consumers that can be linked to a prior customer) can adopt the service at a rate of, e.g., about 3-5 times greater than non-network neighbors selected by the best practices of the firm's marketing team, including sophisticated predictive modeling.

The Dasgupta et al. publication described herein describes lowering a churn in a telecom setting. For example, using communication patterns of millions of mobile phone users, correct predictions of about 50-60% of future churners can be made by, e.g., contacting a relatively small fraction (e.g., approximately 10-20%) of the subscribers. The Doyle publication describes, e.g., an increased churn model performance by a factor of about ten or more by, e.g., using social network data in the telecom sector. For example, it is possible to also use the social network for, e.g., direct marketing, for which they can report that the return on investment can be more than about five times better than for the current campaigns. However, it can be considered that the Doyle publication described herein may not provide details on the operations of their solutions, for example.

Further, one having ordinary skill in the art should understand, in view of the present disclosure, that the exemplary embodiments in accordance therewith may not be considered to be the same as and/or substantially similar to, e.g., clustering and related RFM (Recency-Frequency-Monetary) analysis, according to which customers can be divided into groups with e.g., a maximal similarity between customers within a group, and maximum dissimilarity between customers across groups. For example, according to certain exemplary embodiments, it is possible that no groups can be formed in an exemplary networked data set. Clustering can be considered in a subsequent step, although the richness of networked data can, e.g., provide for significantly more refined applications such as the exemplary marketing and credit risk applications disclosed and described herein above, for example.

Nearest neighbor classifiers can use a defined distance metric to calculate which data instances in the training set are the closest to the test instance with unknown class label (Witten, I. H., and Frank, E., Data Mining: Practical Machine Learning Toos and Techniques with Java Implementations, 2000). The predicted class label is typically the (most frequent) class label of the closest training instance(s). For k nearest neighbors, the class labels of the k nearest training data instances are typically used. It is known that the Euclidean distance metric (two-norm) is often used.

A different way to possibly take advantage of the payment receiver information in the transaction data is to create a dataset with a set of features for each customer denoting which payment receivers it has paid to (similarly for receiving). Then, it is possible to apply a k nearest neighbor (kNN) technique (or other more traditional supervised learning method). However, it is unclear whether such procedure would produce similarly strong results for several reasons. For kNN, fixing k may be problematic as generally the number of known buyers in a local neighborhood can be very small.

Possibly even more problematic, the feature-value representation would be of very high dimensionality (as many variables as there are payment receivers), differently from most traditional structured datasets. The exemplary table below summarizes certain related works.

| | Explicit social network | Social network inferred |
|---|---|---|
| Online | Direct marketing: | Brand advertising: |
| | Richardson and Domingos (2002) | Provost et al. (2009) |
| | Aral et al. (2009) | Collaborative filtering: |
| | | Huang et al. (2007) |
| | | Zheng et al. (2008) |
| Offline | Churn in telecom: | Mktg and credit risk |
| | Dasgupta et al. (2008) | in banking: |
| | Doyle (2008) | Martens and Provost (2011) |
| | Direct marketing in telecom: | |
| | Hill et al. (2006) | |
| | Doyle (2008) | |
| | Fraud detection in | |
| | telecom/counterterrorism: | |
| | Fawcett and Provost (1997) | |
| | Macskassy and Provost (2005) | |

Accordingly, there may be a need to address and or overcome at least some of the deficiencies described herein.

### SUMMARY OF EXEMPLARY EMBODIMENTS OF PRESENT DISCLOSURE

Exemplary embodiments of the present disclosure are directed to methods, computer-accessible medium and systems that can be used to, e.g., generate what can be called a pseudo-social network (PSN). For example, an exemplary PSN can relate to connected entities (e.g., customers) that can have a strong similarity in the payments they make, and receive but likely not know one another and thus have no established social relationship with one another.

Exemplary embodiments in accordance with the present disclosure can focus on the offline banking setting, e.g., where no explicit network data can be available. From an exemplary transaction database containing exemplary money transfers to and from customers, an exemplary network model among customers can be built. Transaction data can be very broadly and can include withdrawals from ATMs, monthly automated payments, check payments, credit card payments and others. Such data can be more richer than typical data on one type of entity (e.g., a customer, product or brand) that can be used, for example. With exemplary available target values (e.g., response to a marketing campaign or churn behavior) for a set of exemplary customers, certain exemplary embodiments according to the present disclosure can predict the response of the others by, e.g., using the exemplary network data through exemplary network classification and/or exemplary collective inference.

For example, with the predictive power of networked data as well as the nature of certain exemplary embodiments provided in the present disclosure, such exemplary embodiments can be of high value for, e.g., marketing purposes in the banking sector. Additionally, exemplary implementations and/or utilizations of exemplary embodiments according to the present disclosure can be provided, e.g., for assessing the creditworthiness of customers, in, e.g., probability of default (PD), loss given default (LGD) and exposure at default (EAD). These exemplary risk parameters can be used, e.g., for regulatory capital requirement calculations in the international Base1 II framework for lending institutions. Further, while the exemplary embodiments of the present disclosure can focus on retail banking, other exemplary embodiments in accordance with the present disclosure can be applied for other asset types, such as, e.g., corporations.

According to an exemplary embodiment of the present disclosure, a process can be provided for generating privacy-friendly pseudo-social networked (PSN) data from off-line banking data. With the exemplary process, it is possible to obtain first data related to at least one financial transaction associated with a first entity, and second data related to at least one financial transaction associated with a second entity. In addition, using a computing arrangement, it is possible to generate a data network graph based on the first data and the second data, and determine a relationship based on at least one similarity of the first data and the second data using information from the data network graph. It is also possible to display or store information associated with the relationship in a storage arrangement in at least one of a user-accessible format or a user-readable format.

According to another exemplary embodiment of the present disclosure, it is possible to provide a computer-accessible medium containing executable instructions thereon. For example, when at least one computing arrangement executes the instructions, the computing arrangement(s) can be configured to perform exemplary procedures, which can include obtaining first data related to at least one financial transaction associated with a first entity; obtaining second data related to at least one financial transaction associated with a second entity; generating a data network graph based on the first data and the second data; and determining a relationship based on at least one similarity of the first data and the second data using information from the data network graph.

In yet another exemplary embodiment of the present disclosure, a system can be provided for determining a token causality. The exemplary system can include a computer-accessible medium having executable instructions thereon. For example, when at least one computing arrangement executes the instructions, the computing arrangement can be configured to obtain first data related to at least one financial transaction associated with a first entity; obtain second data related to at least one financial transaction associated with a second entity; generate a data network graph based on the first data and the second data; and determine a relationship based on at least one similarity of the first data and the second data using information from the data network graph.

According to still another exemplary embodiment of the present disclosure, a method can be provided for determining at least one relationship associated with particular data. With this exemplary method, it is possible to obtain first data associated with at least one first transaction performed by at least one first entity, and second data associated with at least one second transaction performed by at least one second entity. In addition, using a computing arrangement, it is possible to generate a pseudo-social network (PSN) based on at least the first and second data; and determine the relationship(s) using the PSN. Further, the relationship can be used for at least one of marketing or assessing risk.

In an exemplary embodiment of the present disclosure, the PSN can include an inferred network based on characteristics associated with the first data and the second data. In yet another exemplary embodiment of the present disclosure, the PSN can be with at least one predictive model, such as, e.g., a socio-demographic (SD) model, a logistic regression model and/or a support vector machine (SVM) model, the relationship can be determined using the combination of the PSN and the predictive model.

Additionally, the exemplary relationship can: (a) be determined based on a similarity between the first and second data, (b) include an output score, (c) be associated with at least one target variable, and/or (c) include an associated strength based on at least one link in the PSN. The associated strength can include a weighted and/or an aggregated index of at least one networked entity within the PSN.

Further, the exemplary determination of the relationship(s) using the PSN can include generating at least one weighted score associated with each of the first and second entities. For example, the weighted score can include an aggregation of transactions associated with a respective entity of the first and second entities, a micro-affinity factor associated with each of the aggregated transactions, and/or a negative factor associated with at least one of the aggregated transactions.

According to a still further exemplary embodiment of the present disclosure, a computer-accessible medium containing executable instructions thereon can be provided. For example, when at least one computing arrangement executes the instructions, the computing arrangement can be configured to perform procedures, which can include obtaining first data associated with at least one first transaction performed by at least one first entity; obtaining second data associated with at least one second transaction performed by at least one second entity; generating a pseudo-social network (PSN) based on at least the first and second data; and determining at least one relationship using the PSN. Further, the exemplary relationship(s) can be used for at least one of marketing or assessing risk In another exemplary embodiment of the present disclosure, the PSN can include an inferred network based on characteristics associated with the first data and the second data. In another exemplary embodiment, the PSN can be with at least one predictive model, such as, e.g., a socio-demographic (SD) model, a logistic regression model, and/or a support vector machine (SVM) model, the relationship(s) can be determined using the combination of the PSN and the predictive model.

Additionally, the relationship can: (a) be determined based on a similarity between the first and second data, (b) include an output score, (c) be associated with at least one target variable, and (c) include an associated strength based on at least one link in the PSN. The associated strength can include a weighted and/or an aggregated index of at least one networked entity within the PSN.

Further, the exemplary determination(s) of the relationship(s) using the PSN can include generating at least one weighted score associated with each of the first and second entities. The weighted score can include an aggregation of transactions associated with a respective entity of the first and second entities, a micro-affinity factor associated with each of the aggregated transactions, and/or a negative factor associated with at least one of the aggregated transactions.

These and other objects, features and advantages of the present disclosure will become apparent upon reading the following detailed description of exemplary embodiments of the present disclosure, when taken in conjunction with the appended drawings and claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIGS. 1(a)-(d) are diagrams of an exemplary network models used to convert transaction data to a networked model according to exemplary embodiments of the present disclosure;

FIGS. 2(a) and (b) are ROC and lift graphs according to exemplary embodiments of the present disclosure;

FIG. 3 are graphs of exemplary learning curves for exemplary products according to exemplary embodiments of the present disclosure;

FIGS. 4(a) and (b) are profit graphs for exemplary products according to first exemplary embodiments of the present disclosure;

FIGS. 5(a) and (b) are profit graphs for exemplary products according to second exemplary embodiments of the present disclosure;

FIGS. 6(a)-(c) are profit graphs for exemplary products according to third exemplary embodiments of the present disclosure;

FIGS. 7(a)-(c) are profit graphs for exemplary products according to fourth exemplary embodiments of the present disclosure;

FIG. 8 is a graph showing an exemplary output score according to exemplary embodiments of the present disclosure;

FIGS. 9(a) and (b) are input selection graphs for exemplary products according to exemplary embodiments of the present disclosure;

FIG. 10 is a flow diagram according to exemplary embodiments of the present disclosure; and

FIG. 11 is a system block diagram according to exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures and associated with the claims that follow.

### DETAILED DESCRIPTION OF EXEMPLARY EMBODIMENTS

### Exemplary Embodiment of Setting an Exemplary Bank Scene

The banking industry can be considered to have played a pioneering role in, e.g., the wide-scale application of data analysis methods and systems. The source of exemplary transactional payment data and exemplary bank-specific data analysis applications can be considered relevant to certain exemplary embodiments in accordance with the present disclosure. For example, the payment data can differ between what can be called a European model and an American model. Certain exemplary embodiments according to the present disclosure can be applied to both exemplary models. Further, exemplary applications can be situated in marketing and/or credit risk management.

### Exemplary Typical Fund Transfers

Exemplary European Model: Wire Transfer

A wire transfer can be considered to be a method of transferring money from a bank account of one entity (e.g. a person or company) to another. In Europe, e.g., a bank transfer is a common payment methods. Debit cards can be used extensively to pay in stores, while monthly bills usually can be paid with a direct transfer. The Single Euro Payments Area (SEPA) initiative from the European Payments Council created a zone comprising 32 European companies where payments can be considered to be domestic (European Payments Council, 2008). Both domestic wire transfers and wire transfers within SEPA can have the same cost, which can be very little to nothing. Accordingly, SEPA payments can be very popular and may be the most dominant way of making an electronic payment in Europe in the next decade.

Exemplary American Model: Credit Card Payment

Credit cards can provide lines of credits to customers which can be used by the customer to, e.g., buy goods and services up to the credit card limit. A monthly balance is typically paid by the customer to a bank. Alternatively, the balance can be revolved at the cost of a monthly interest rate.

Although credit cards can be commonly used worldwide, they can be a typical method of payment in the United States. In Europe credit cards can also be used for purchases of goods and services, although use of an exemplary wire transfer method, such as described herein above, is typically more common. Within the context of an exemplary transaction log of payments, as disclosed and described herein, this exemplary payment method can therefore be referred to as the American model.

Exemplary Analytics Applications

Advanced analytics of data can be popular in the banking industry, mainly in the marketing and risk management areas, for example. Exemplary embodiments according to the present disclosure can be applied to both.

Exemplary Customer Analytics

Typical marketing applications of data analytics can involve, e.g., exemplary response or propensity modeling, and churn prediction. Exemplary response modeling can aim to predict which customers can be likely to respond positively to a certain offering (e.g., on a certain product, service or event). Exemplary churn prediction can aim to identify customers, e.g., with a high probability to attrite. These exemplary problems can be classification tasks with the target variable being discrete.

Customer lifetime value can be a regression task that can be related to churn prediction, and can involve, e.g., assessing a customer's value to the company based on benefits and costs the customer can be considered as providing the bank up until the moment of attrition, for example.

The bank setting can provide that on which certain exemplary embodiments according to the present disclosure can focus, e.g., another marketing issue within an exemplary credit card setting, which can be called share of wallet. For example, according to certain exemplary embodiments of the present disclosure, the total amount spent on credit cards can be approximated as the sum of the limits of all the credit lines associated with such credit cards. Thus, taking into account the credit line at the bank itself, share of wallet can be calculated and hence predicted.

Exemplary Credit Scoring

The recent introduction of the Base1 II Capital Accord can encourage financial institutions to calculate their minimum regulatory safety capital to substantially and/or reasonably ensure that they can be able to return depositor funds upon whenever requested (See, e.g., Base1 Committee on Banking Supervision, 2006). For example, the minimum safety capital can be determined to be at 8% of risk weighted assets, which can in turn be quantified by taking into account several types of risk, such as: credit risk, operational risk, and market risk. When calculating credit risk, banks can use three exemplary risk parameters, such as probability of default (PD), loss given default (LGD) and exposure at default (EAD). These exemplary parameters can then be used as input to, e.g., a Merton/Vasicek model which can then calculate the regulatory safety capital. (Id.)

The exemplary PD, LGD, and EAD parameters can be obtained in different ways. For example, what can be considered to be a standard approach can facilitate banks to buy these exemplary parameters from, e.g., external rating agencies, which can often be called External Credit Assessment Institutions (ECAIs) in the spirit of the related accord. Moody's, Standard & Poor's, and Fitch can be considered as examples of relatively well-known ECAIs. The foundation internal ratings based (IRB) approach can allow banks to, e.g., build their own PD models and get LGD and EAD estimates from exemplary supervisors. Accordingly, the advanced internal ratings based approach can allow financial institutions to estimate the three risk parameters themselves. Thus, the majority of financial institutions may already have, or likely will, adopt an advanced IRB approach, triggering an interest and/or need to develop credit scoring and bankruptcy prediction models that can be used, for example to estimate the PD of a set of obligors.

PD estimation can be interpreted as a classification problem which can distinguish good customers from bad ones, while LGD and EAD can be interpreted as regression problems. EAD can be of particular importance for credit cards, where there can be a need for estimating a substantially exact exposure at default and hence the amount of credit drawn from the card line, for example.

### From Exemplary Transaction Log to Exemplary Networked Data Graph

Exemplary Methodology

Exemplary embodiments according to the present disclosure can create, e.g., an exemplary pseudo-social network model methodology among customers, linking those with similar payment profiles, based on an anonymized transaction log with money transfers. Subsequent exemplary classification and network inference can provide knowledge that can be used to, among other things, increase sales and loyalty in marketing applications or reduce risk (credit, operational, market) in risk applications.

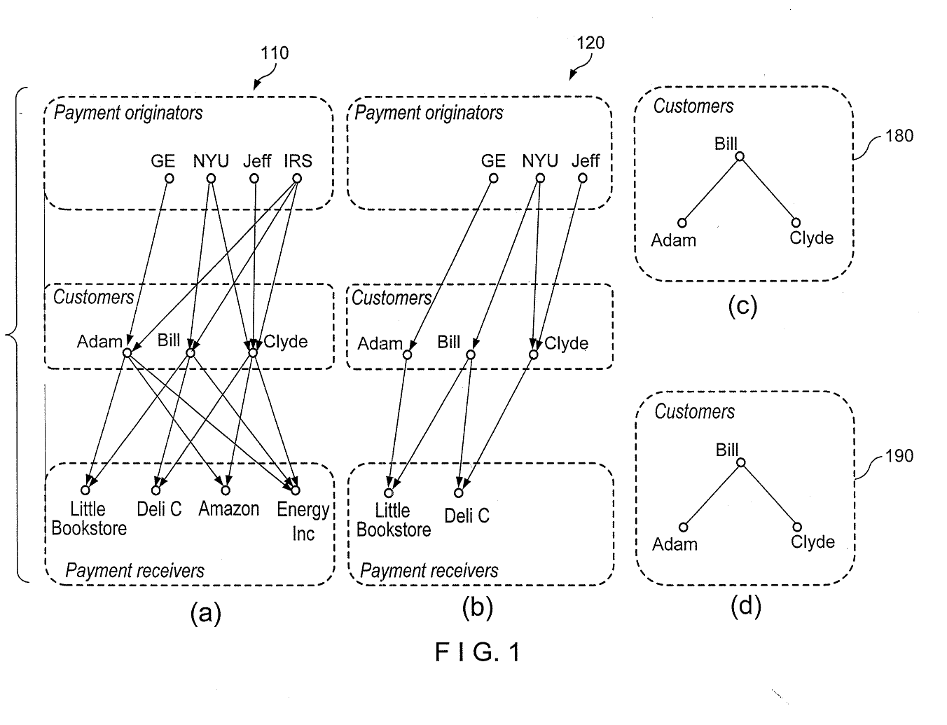

Certain exemplary embodiments can include an exemplary transaction log that can contain money transfers to and from customers, which can be visualized, for example, as the relatively simple example 110 illustrated in FIG. 1(a). FIGS. 1(a)-(d) show exemplary network models from an exemplary transaction log of payments to exemplary network models among customers for a simple example. For example, payments to and from customers can be visualized by denoting an entity as a node and a payment as a directed edge. FIG. 1(b) shows exemplary model(s) 120 having implemented micro-affinity factors and removing common payment originators or receivers. A further exemplary network model can be built by defining an edge between two customers if they have a common payment originator, or payment receiver, as shown, for example, in FIG. 1(c), and FIG. 1(d) illustrates an exemplary networked data model 180, 190, respectively, where an inference on the target label can be made. An exemplary basic notation of similarity in this exemplary setting can be that two customers can be similar if they make payments to the same entity or receive payments from the same entity. According to certain exemplary embodiments of the present disclosure, these two exemplary customers can be considered to have a greater similarity to one another based on there being more of such connections shared between them.

In certain exemplary cases, there can be companies to which many customers pay, such as, e.g., telecommunication operators or energy providers, which can provide relatively little information on the similarity between two customers while swamping and/or concealing more informative links that can be shared between customers, such as, e.g., customers shopping at the same small store. According to certain exemplary embodiments of the present disclosure, such exemplary common connections can be omitted or down-weighted. In exemplary cases in which customers receive money, there can also be entities that pay many customers, such as the Internal Revenue Service, which can pay tax refunds, for example. According to certain exemplary embodiments of the present disclosure, such exemplary common connections also can be omitted or down-weighted. Certain exemplary methods that can be used to select the relevant connections automatically can include, e.g., tfidf and likelihood ratio. Taking such micro-affinity into account can yield the example 120 illustrated in FIG. 1(b). Further, according to certain exemplary embodiments of the present disclosure, a data network graph can be generated from such model. For example, if two customers receive a payment from the same entity, a link can be created between them, which can provide an indication of their similarity. For example, both Bill and Clyde receive a monthly payment from NYU indicating that they both work at NYU. Similarly, if two customers make a payment to the same entity, a link can be created between them as well. For example, both Adam and Billy shop at the Little Bookstore. Exemplary embodiments according to the present disclosure can check separately if more information can be in the edges generated by, e.g., a shared payment originator, shared payment receiver, or combined. The weight of the link and/or connection can depend on several characteristics, as provided herein below.

### Exemplary Applications of an Exemplary Networked Data Model in a Bank Setting

Exemplary Embodiment of Using Networked Data for Marketing Purposes

Once an exemplary network model has been generated, it is possible to predict which customers can be likely to respond to certain exemplary marketing campaign (e.g., similar targets can be defined for other marketing applications such as, e.g., churn prediction). For some customers, it can be known whether they responded in the past, and can have a known target label, for example. An exemplary class label can be predicted for a customer by, e.g., taking the most frequent class label among the network neighbors (or use an exemplary inference procedure by, e.g., taking into account the exemplary weights). According to certain exemplary embodiments of the present disclosure, inferring exemplary target values for the considered customers can be done through collective inference. For example, a listing and explanation of certain exemplary techniques to do so can be found in, e.g., Macskassy, S. A., Provost, F., Classification in networked data: A toolkit and a univariate case study, Journal of Machine Learning Research 8, 935-983, 2007. According to certain exemplary embodiments, the combination with other data sources, including text, can also be used.

Exemplary Embodiment of Using Networked Data for Risk Management Purposes

The same exemplary network and inference methods discussed above can be applied for, e.g., risk management and PD, LGD and EAD estimation. A supplementary condition here, however, can be for comprehensibility of an exemplary revised and/or final model. For example, since these exemplary models can play what can be considered to be a pivotal role in a risk management strategy of a bank, they can also be subject to, e.g., supervisory review and validation by financial regulators. Furthermore, in can be that in most countries, financial institutions can be obliged to explain why credit has been denied to an applicant, for example. Both these trends can inhibit and/or prohibit the use of, e.g., black box, mathematically complex application scoring models, but also can disallow, e.g., a simple listing of risky customers based on the PSN.

Extracting exemplary rules that can mimic exemplary predictions made based on exemplary PSN data can provide a solution for this exemplary problem. Exemplary embodiments can include applying an exemplary rule and/or tree induction technique on an exemplary database with traditional customers' predictive variables and an exemplary target set at exemplary PSN-provided values, for example. This can be different from using the actual values for the target variable, as the exemplary predictions from the PSN-based method can be explained by exemplary rules. If the exemplary rules mimic the exemplary PSN-based predictions closely enough, it could be argued that enough explanation can be provided and the exemplary PSN-based predictions can be used, e.g. for credit scoring. Rule extraction has been applied in some cases in attempts to, e.g., explain black box models as support vector machines (Martens et al., 2009) and artificial neural networks (Baesens et al., 2003). The generation of additional artificial data points (See, e.g., Craven, M. W., Extracting comprehensible models from trained neural networks. Ph.D. thesis, University of Wisconsin-Madison, supervisor-J. W. Shavlik, 1996; and Martens, D., Van Gestel, T., Baesens, B., Decompositional rule extraction from support vector machines by active learning, IEEE Transactions on Knowledge and Data Engineering 21 (2), 178-191, 2009) can be beneficial in this context as well, for example.

An alternative exemplary technique and/or method according to the present disclosure can characterize the actual relationships using exemplary features of the exemplary linked entities, and explain the exemplary model predictions based on exemplary commonalities among these, using exemplary real-learning procedures as disclosed and described above, for example. If exemplary communities can be detected in the exemplary networked data (e.g., using clustering techniques), it is possible to, e.g., also explain the exemplary similarities within an exemplary community of customers.

Transactions between the same entities can be aggregated in forming the exemplary network. For example, to reduce noise, it is possible to use: (i) those transactions that exceed a certain minimum amount; or (ii) those links for which the aggregated transactions exceed a certain minimum amount; or (iii) only transactions that exceed a certain link strength or weight. An exemplary inferred network model among customers can be named a pseudo-social network. Strongly connected customers can demonstrate a strong similarity in the payments they make and receive but can have no true and/or traditional social relationship with one another.

Exemplary weight and/or strength of a link or connection can be determined in various ways in accordance with certain exemplary embodiments of the present disclosure, which can take into account, e.g., various kinds and/or types of metrics such as the number of shared connections they share, as well as the frequency and momentary similarity in payments. For example, this can be determined using the summation of the strengths of the edges between two exemplary customers, or by some other aggregation function. The strength of an edge corresponding to a payment and/or receipt to a joint entity can be augmented by the similarity of the payment amounts. If, for example, NYU pays Bill $X and Clyde $X/2, it can likely be an indication that Bill and Clyde having different kind of jobs or seniority and should therefore have a link with a weaker strength than if Bill and Clyde were to receive the same amount (e.g., $X each).

### From Exemplary Transaction Data to an Exemplary Pseudo-Social Network Based Scores

In yet another exemplary embodiment of the present disclosure, focus can be placed on shared payment receivers. Similarly, taking into account shared payment originators can also be included.

The payment transactions are preferably first converted to a payment receiver matrix listing each customer making payments. This task can be performed incrementally on the complete payment transaction dataset, resulting in a dataset as shown, for example, in Table 1. Next, a score for each customer (e.g., a through i in this example) can be obtained. For a given target product, customers that have previously bought the product can be called “known buyers” (more generally, “known positive instances”). Typically, the calculation of the score for a customer x measures the strength of the links x has to known buyers.

In considering that a link between customers can be defined by making a payment to the same payment receiver (PR), the overall score for x can be the sum of the scores for all payment receivers to whom x made a payment. This score per PR can reflect a strength measure, such as the ratio of known buyers that made a payment to the PR over the total number of (unique) customers making a payment to the PR. Typically, the higher this ratio, the more indicative the PR can be for the target variable (e.g., buying). Further, taking into account an exemplary micro-affinity concept, where payments receivers with only few customers can provide more information than those with many, the factor Inverse Customer Frequency (ICF) can be introduced, which can be defined by Eq. (1) herein. This factor can provide an indication of the strength of the tie between a customer making a payment to a specific PR. Such exemplary concept can be analogized to a relevance measure used in text mining, where, for example, terms occurring only in few documents receive higher weights, known as Inverse Document Frequency. The score can be defined in Eq. (2).

number of customers
npr=number of payment receivers
NC(pr)=number unique customers having made a payment to pr

NB(pr)=number of unique known buyers having made a payment to pr

B(x,pr)=1 if customer x made a payment to pr
=0 if customer x did not make a payment to pr

$$\begin{matrix}I C P ( PR ) = {log}_{10} ( \frac{nc}{NC ( pr )} ) & ( 1 ) \\ Score ( x ) = {\sum }_{i = 1}^{npr} ( \frac{NB ( {pr}_{i} )}{NC ( {pr}_{i} )} \times ICF ( {pr}_{i} ) ) \times B ( x , {pr}_{i} ) & ( 2 )\end{matrix}$$

The exemplary calculation of this score can be illustrated further with the simplified example, as shown, for example, in Table 1. For each PR, the customers that made a payment to it can be listed, and the known buyers can be denoted in boldface. The number of unique customers NC(pr) and number of known buyers NB(pr) can be shown in the subsequent columns. For example, assuming that the bank has a total of 100 customers (nc=100), the inverse customer frequency ICF(pr) can be calculated and is given in the final column. Based on these summary statistics, a score for each of the non-known buyers can be obtained.

TABLE 1
Example from transaction payment (pr) to PSN. The known buyers
among the customers are denoted in boldface.

| pr | Customers | NC(pr) | NB(pr) | ICF(pr) |
|---|---|---|---|---|
| Little BookStore | a b c | 3 | 2 | 1.52 |
| DeliC | a d e | 3 | 0 | 1.52 |
| Amazon | f g h i | 4 | 1 | 1.40 |
| EnergyInc | b c d e f g | 6 | 3 | 1.22 |

For example, customer a made a payment to two payment receivers, e.g.: LittleBookStore and DeliC. Therefore:
B(a,Little BookStore)=B(a,DeliC)=1
B(a,EnergyInc)=B(a,Amazon)=0

Hence, the score for a can be given by the sum of the score for LittleBookStore and DeliC, where each of these scores can be determined by the known buyer density NB(pr)/NC(pr) and ICF(pr), as calculated, for example, in Eq. (3) herein. For customer b, the scores for DeliC and EnergyInc can be summated, providing a score of 0.61. The same calculations can be done for the other non-known buyers:

$$\begin{matrix}\begin{matrix}Score ( a ) = {Score}_{LittleBookStore} + {Score}_{DeliC} \\ = ( \frac{2}{3} \times 1 , 52 ) + ( \frac{0}{3} \times 1 , 52 ) \\ = 1 , 01\end{matrix} & ( 3 ) \\ \begin{matrix}Score ( d ) = {Score}_{DeliC} + {Score}_{EnergyInc} \\ = ( \frac{0}{3} \times 1 , 52 ) + ( \frac{3}{6} \times 1 , 22 ) \\ = 0 , 61\end{matrix} \\ Score ( e ) = 0 , 61 \\ Score ( f ) = 0 , 96 \\ Score ( h ) = 0 , 35 \\ Score ( i ) = 0 , 35 & ( 4 )\end{matrix}$$

In this example, the highest score can be obtained by customer a. This high score can originate from LittleBookStore, which may receive relatively few payments (e.g., strong ties between the few customers that make payments there) and most of the customers may be known buyers (e.g., leading to a strong indication of relative likelihood to buy the product).

### Exemplary Alternative Embodiments of the Present Disclosure

Further exemplary embodiments of the present disclosure can distinguish between, for example, the money transfer data to consider, the definition of a link, the weights of a payment receiver (or payment originator) and the calculated scores.

Exemplary Money Transfer Data

A broad range of money transfers types exist, for example: credit and debit payments, money withdrawals, check payments, or any other form of registered money transfer. For each, both the money transfer originators and/or receivers can be used to define links.

Exemplary Definition of Links

Using money transfer data, links can be defined using any combination of the different types. Further, additional data that is available about the money transfer can be used and/or a subset of these transactions can be used.

Similarity in monetary values can be used to further refine links' strengths. Often, comment fields accompany money transfers, which can also be used with text mining algorithms to define links as well. Further, if attributes are available about the PRs or payment sources, these attributes can further affect link strength (e.g., if certain types of PRs tend to have more predictive influence).

Subsets over time can improve scalability and performance. For example, they can be used to detect seasonality effects. Subsets over money transfer receivers/originators can also be included, for example, by considering those that receive few payments (e.g., hence with a high ICF).

Exemplary Definition of Weights of a Money Transfer Receiver/Originator

According to certain exemplary embodiments of the present disclosure, the weight of a money transfer receiver/originator can include a logarithmic metric that favors those with few transfers (e.g., through the calculation of ICF). Other metrics and weighting schemes can be based, for example, on maximum likelihood, such as Bayesian estimates and/or expert knowledge.

Exemplary Definition of Scores

The final calculation of the output score for a customer can be defined by the neighbors in the PSN, e.g., those customers with a shared money transfer receiver/originator. The strength of a link can be the sum of the ICF of the shared payment receivers. This can result in a multiplier of number of known buyers over number of customers for a single payment receiver. It is also possible to also include negative multipliers, for example, where payment receivers with very few known buyers can lower the score. Additionally, schemes, for example, that learn optimal weights for each payment receiver can improve this further.

For regression tasks, such as customer lifetime value or share of wallet prediction, the scores can be defined similarly, for example, by effectively combining the distribution of the output values of the neighbors, which can be discrete in classification tasks (and, e.g., in the example case defined as the average, weighted by the strengths of the links) and continuous for regression tasks.

More advanced learning schemes can be applied to the constructed PSN to calculate scores, for example, those using neighbors of higher degree (e.g., neighbors of neighbors, and beyond), and using advanced relational learners with collective inference (Macskassy and Provost, 2007). The combination of the PSN model with other models built using other data (such as product usage data, macro-economic data, textual data, etc.) could also improve the performance further. The PSN can also be used for applications different from predictive tasks, such as clustering of customers or information propagation. For example, the PSN can be used as features in certain predictive models, such as logistic regression and/or a support vector machine (SVM) model. This can enhance the performance of the exemplary models, and can be an additional effective use of the PSN.

### Exemplary Response Modeling with Real-Life Payment Transaction Data

Exemplary Data Characteristics

Exemplary embodiments of the present disclosure can be used and/or implemented on real-life payment transaction datasets. In an exemplary experiment implementation and/or utilizing certain exemplary embodiments of the present disclosure, a real-life payment transaction from a major European bank was used. In the exemplary dataset, data over a period of 11 months was obtained, with over 5 million (debit) transactions made by 1.2 million customers to a total of 3.2 million unique payment receivers. Accordingly, the buying of a financial product during that time period can be the concern. Target variables were obtained, for example, such as a pension fund product with about 20% of the customers buying the product. Another product can include a long term deposit, for example, with 3% of customers buying the product at the bank. Typically, no targeted campaign took place beforehand. In addition to the exemplary payment transaction data, 289 traditional variables, for example, can be available for the customers, which can summarize, for example, socio-demographic characteristics, product possession, product use and customer behavior. This type of data is traditionally used by large banks for their customer analytics applications.

Exemplary Experimental Setup

The data can be split up into training and test data, where the customers in the training data that bought the product can be the known buyers, and the customers in the test data can be scored (e.g., concealing the true buyer status for the experiment, until the time of evaluation). The resulting model can be denoted as PSN model.

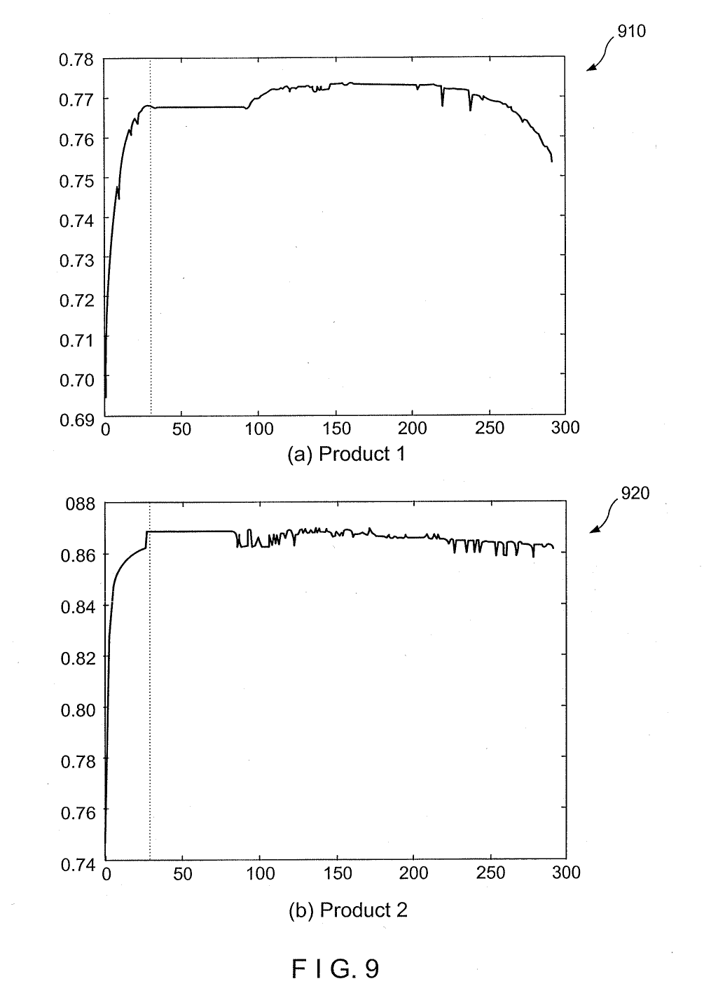

As a benchmark, a linear SVM model using, for example, the 289 traditional variables can be built on a balanced sample from the training set: the known buyers can be included and just as many randomly taken non-known buyer customers from the training set can be included. A forward input selection procedure based on AUC can be used with a maximum, for example, of thirty variables. For example, FIG. 9 shows graphs of AUC 910, 920 for an increasing number of inputs. In FIG. 9, e.g., input selection was performed with a maximum of 30 input variables, as a plateau is reached at that point for both products (marked with the dotted line). A validation set (e.g., chosen as a third of the training set) can be used to determine the optimal number of variables. Although more than just socio-demographic data is typically included in this dataset, for simplicity, the resulting model can be named the Socio-Demographic (SD) model.

Another exemplary model according to the present disclosure can also be assessed, which can include the combination of the PSN and SD model, to see whether the scores from the PSN can improve the performance of the SD model. In this exemplary experiment, e.g., a linear combination of the two scores can be used. The PSN output score can be resealed to the interval [0, 1] by subtracting the minimum and dividing over the range. Positive examples and negative examples can be chosen, for example, to create a balanced sample. Since a PSN score is typically only obtained for the test data, the combined model may be limited to be estimated on the test set. For example, 10% of the test set can be used to estimate the weights that combine the two output scores, and the remaining 90% can be used as true test set to evaluate the performance of the models. The combined model can be denoted as PSN+SD.

The exemplary PSN procedure can be implemented in Matlab, while the SVM model can be built, for example, using the LIBLINEAR package (Fan et al., LIBLINEAR: A Library for Large Linear Classification, Journal of Machine Learning Research 9, 1871-74, 2008). Experiments can be conducted, for example, on an Intel Core 2 Quad (3 GHz) PC with 8 GB RAM.

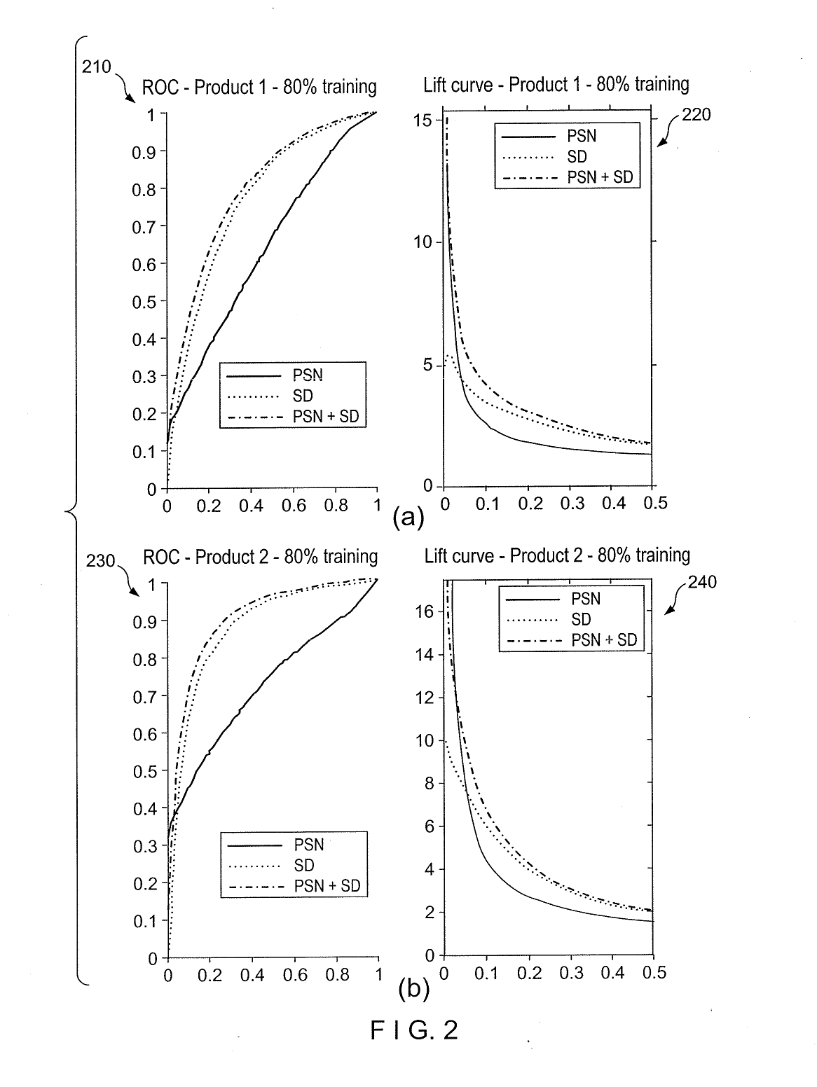

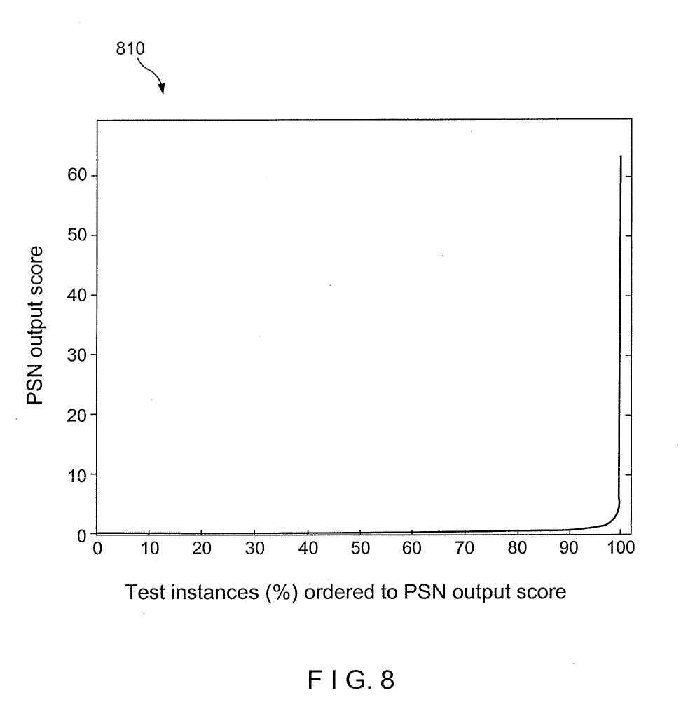

Exemplary Results in ROC and Lift When 80% of the data is used as training data, the results for the two products in terms of AUC and lifts at 1, 5 and 10% are given, for example, in Tables 2 and 3. The PSN model seems to perform quite badly when viewed in terms of AUC, however, it does extraordinary well for the lift at 1%. This good lift performance can fall at the higher percentiles. Thus, the PSN can do a good job high score range, e.g.: the top-rated customers can be likely to be good candidates to buy the product. Given the typical limited budget for marketing campaigns, the marketing campaigns are often limited to these very high percentiles. The exemplary ROC and lift curve shown, for example, in FIG. 2 further illustrates this performance. FIGS. 2(a) and 2(b) shows graphs of ROC (left) 210, 230 and lift curves (right) 220, 240 for the exemplary pseudo-social network (PSN) model, the model with traditional characteristics, including sociodemographic data (SD) and the exemplary combined model (PSN+SD). Once these high percentiles have been passed, the exemplary PSN model (e.g., full line) may not perform as well, with the ROC becoming almost a straight line—e.g., the exemplary PSN model may not distinguish these customers. The reason can be that the PSN model only provides a non-trivial score to a few customers (e.g., which seemingly are indeed very likely candidates for the product). As the neighbors of existing customers can be provided with a score, most of the social network can remain unscored. For example, FIG. 8 shows a graph 810 of the output score of PSN model for product 1, with the customers ranked according to the output score (similarly for product 2). As shown in the graph 810 of FIG. 8, for example, most customers receive a (near-)zero score while a few receive a high score. More advanced network learning schemes, for example, including collective inference, can further improve the performance of inference over the exemplary pseudo-social network. For example, the performance curve for the exemplary SD model (dotted line), can exhibit a more typical form. The exemplary SD model can perform worse than the PSN model at the high score range and can perform better everywhere else.

The exemplary results of the combination of these two models (PSN+SD) is very encouraging. It can show that the PSN score typically has complementary predictive power to the traditional scoring, and can perform very well over the complete range of scores.

TABLE 2
Results product 1 - 80% training data.

| | AUC | Lift 1% | Lift 5% | Lift 10% |
|---|---|---|---|---|
| PSN | 63.7 | 15.1 | 4.1 | 2.6 |
| SD | 76.3 | 5.0 | 4.2 | 3.5 |
| PSN + SD | 79.2 | 16.2 | 5.9 | 4.3 |

TABLE 3
Results product 2 - 80% training data.

| | AUC | Lift 1% | Lift 5% | Lift 10% |
|---|---|---|---|---|
| PSN | 0.72 | 30.5 | 7.8 | 4.4 |
| SD | 0.86 | 9.7 | 7.6 | 6.0 |
| PSN + SD | 0.89 | 17.6 | 9.9 | 6.8 |

Exemplary Effect of More Exemplary Data

For example, the exemplary PSN model can be affected by the amount of data available, for example: more data typically means more connections among consumers, but more importantly, more data typically means more known buyers become available for inference. Accordingly, the exemplary results may be conservative compared with what might be expected across a large bank's entire customer base (e.g., which could be one or two orders of magnitude larger).

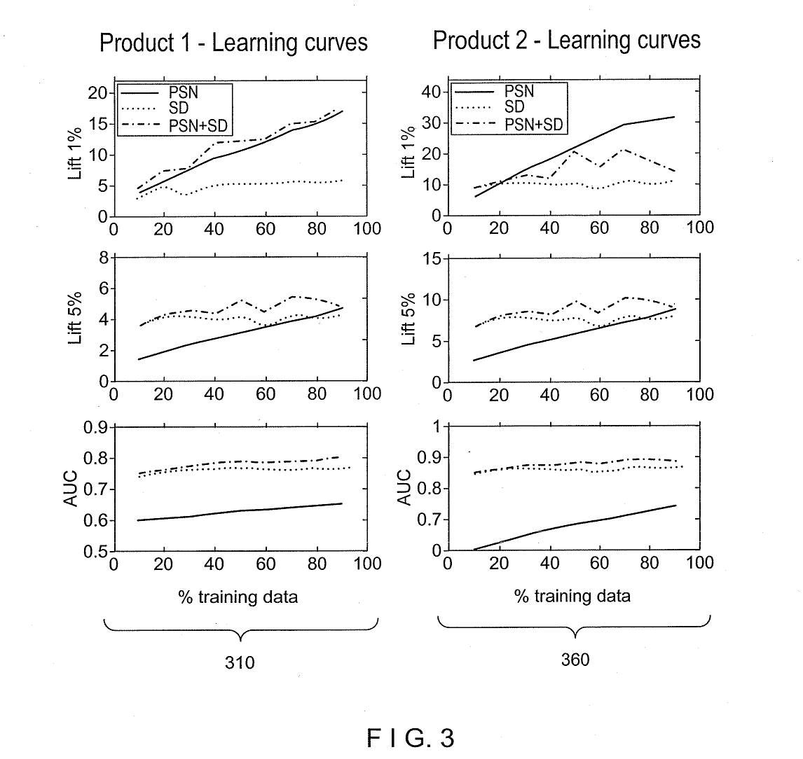

Exemplary embodiments of the present disclosure can assess the effect of the data size within the range of the exemplary sample by simulating different data sizes. In graphs of FIG. 3, the evolution of the performance metrics for the models (PSN, SD and PSN+SD) is shown as training data is increased. For example, FIG. 3 shows learning curves, e.g., performance metrics on the test set 310 for product 1 (left) and the test set 360 for product 2 (right) for increasing training size. As shown in graphs 310, 360 of FIG. 3, for the exemplary PSN (and exemplary combined PSN+SD model), the performance improves as additional training data is added, unlike for the SD model. Accordingly, further performance improvements can be expected with larger data sets.

As expected, the AUCs and lifts for the exemplary PSN model (e.g., full line) increase the number of known buyers increases, and can do so relatively constantly across the range. As more known buyers become available, more customers in the network will typically receive a non-trivial score. This trend is typically not observed for the performance metrics of the SD model. As typically observed in data mining applications (see, e.g., Perlich et al., Tree Induction vs. Logisitc Regression: A Learning Curve Analysis, Journal of Machine Learning Research 4, 211-55, 2003), from a certain sample size on, no further performance improvements are typically obtained by adding data.

This indicates that further model improvements for the exemplary PSN model (and the combined PSN+SD model) with larger data sets, even though data on a very large number of customers can already have been used. If this trend does continue for orders of magnitude more data, the largest banks can be said to have a “data asset” from which they could get a higher return than banks with smaller customer bases.

In terms of inference time a constant increase can also be observed, but run time typically remains below an hour. Since the exemplary PSN model can be built incrementally, e.g., as new data becomes available, it can be updated quickly. Most time can be spent on the initial preprocessing of the data, for example, where the payment transaction data can be processed to the lists of customers for each payment receiver (e.g., as indicated in Table 1). This can use about a day of computations to incrementally read in and process parts of the transactions. For this preprocessing step as well, new data can simply be added incrementally.

Exemplary Results: Profit

The parameters to determine the profit of a direct marketing campaign can include (Piatetsky-Shapiro, G., and Masand, B., Estimating Campaign Benefits and Modeling Lift. Proceedings of the fifth ACM SIGKDD International Conference on Knowledge Discovery and Data Mining, 185-93, 1999):

N: the total number of customers

T: the fraction of target customers, who have the desired behavior (e.g., response to offer, in this case the percentage that are buyers).

B: Benefit of an accepted offer by a customer correctly identified as a target.

C: Cost of making an offer to a customer, whether a target or not.

The profit of a response model when making an offer to the top P percent of all customers (e.g., those with the highest output score) can be defined by Eq. (5). This can calculate the benefits of the N•P•T•Lift(P) targeted customers that actually accept the offer, minus the costs incurred by making an offer to N•P customers.

Profit=N•P•(T•Lift(P)•B−C) (5)

The percentile P can be selected such that the profit can be maximized and therefore can be dependent on the aforementioned parameters. For the problem from which the exemplary dataset was drawn, the parameters are given below (rounded for confidentiality reasons). These cost and benefit estimates and ranges have been verified by the bank.

N=10⁶

T_{P1}=0.2

T_{P2}=0.03

Benefit (in [symbol] ):
Example Product 1 Hypothetical (pension fund): Each year a customer pays on average 500 [symbol] ; if a bank gets 1% transaction cost. Possibly more importantly, customer lifetime value increases substantially as this is a very long-term product, therefore:
   B_{P1 lowerbound}=5
   B_{P1 upperbound}=1000
   B_{P1 estimated}=500
Example Product 2 Hypothetical (long term deposit account): the return depends on the market, estimated between 0.1 and 1%. The average investment can be between 5000 [symbol] and 50.000 [symbol] :
   B_{p2 lowerbound}=500*0, 001=5
   B_{p2 upperbound}=50000*0, 01=500
   B_{p2 estimated}=300
   Cost (in [symbol] ): the cost of making an offer can be the same for both products and limited to sending out a letter or folder. The design of the campaign and the time of bank managers that talk to the responding customers can be considered fixed.
   C_{P1,2 lowerbound}=1
   B_{P1,2 upperbound}=10
   B_{P1,2 estimated}=3

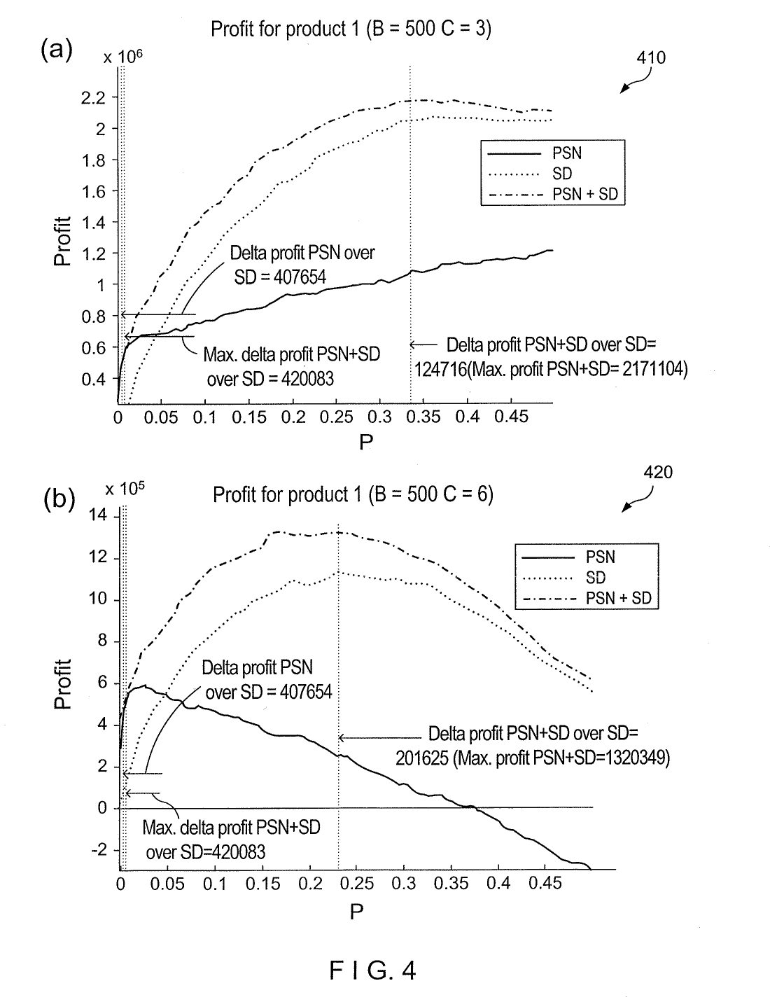

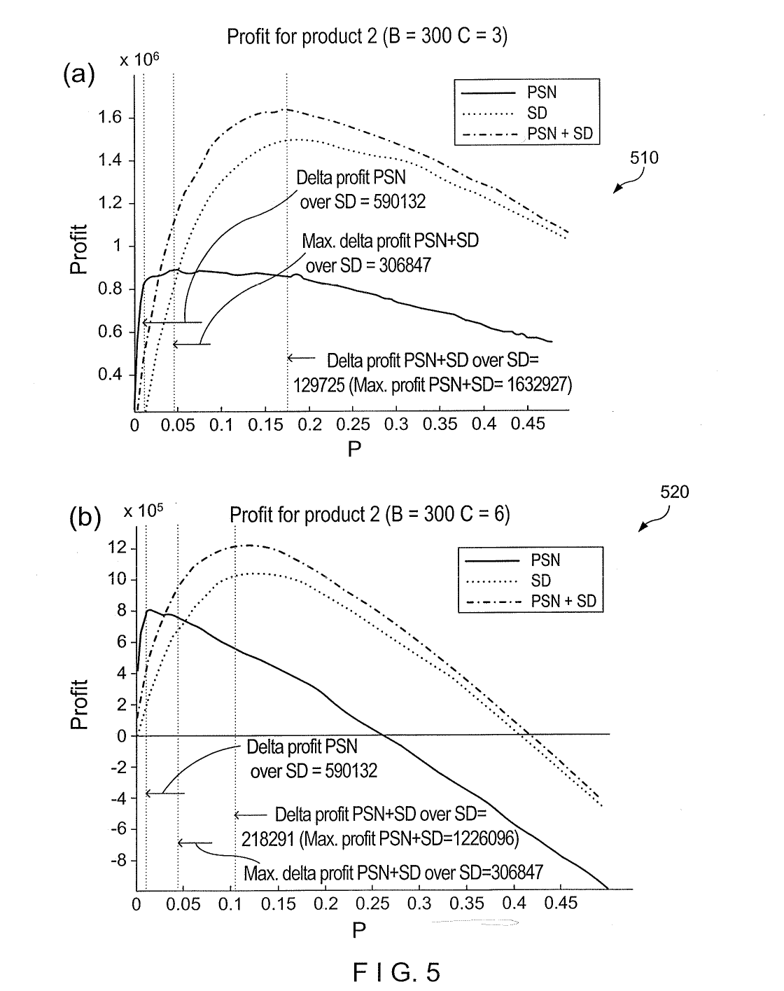

With an estimated values of 500 [symbol] as the benefit of an accepted offer and 3 [symbol] the cost of making an offer for product 1, the profit lines for the exemplary models (PSN, SD, PSN+SD) is shown in a graph 410 of FIG. 4(a). At the very high percentiles (e.g., very low values for P), high lifts can be obtained and many of the targeted customers will typically respond. Therefore profit can increase as P increases. At a certain point, however, (e.g., around P=30% for the PSN+SD model) the lift may not be high enough for the benefits to outweigh the costs and the profit starts to decrease. The highest profit can be 2.171.104 [symbol] , obtained by the PSN+SD model around P=30%. Since it can find more customers that respond (and hence higher benefits) compared to the SD model, an additional 124.716 [symbol] in benefits can be given over the SD model. The graph 410 of FIG. 4(a) also shows the maximum profit achieved for the PSN and the difference in profits with the SD model (‘Delta profit PSN over SD’), as well as the maximal difference in profit between the PSN+SD and SD model (‘Max delta profit PSN over SD’). FIG. 4(b) shows a graph 420 of the result when the estimated cost C is doubled to 6 [symbol] , which can lower the profits and leads to a smaller set of targets (e.g., smaller percentage of the population) to be chosen to achieve maximal profit. Since the exemplary PSN model (and PSN+SD combination) can perform better at the lower percentiles, the improvement of the combined model PSN+SD can be higher (201.625 [symbol] ) even though the total profit can be lower. The profit curves for product 2 are shown in respective graphs 510 and 520 or FIGS. 5(a) and 5(b), respectively, (with B=300 and C=3 or 6), with an additional 129.725 [symbol] in profits achieved by the combined PSN+SD model for the estimated benefit and cost.

Practically, firms often may not select the number of targets based on an optimality calculation. In many cases, other issues can constrain the targeting budget to a much smaller number. These results suggest that adding the PSN model can improve even more in such cases—e.g., the profit difference from not including the PSN information can be larger.

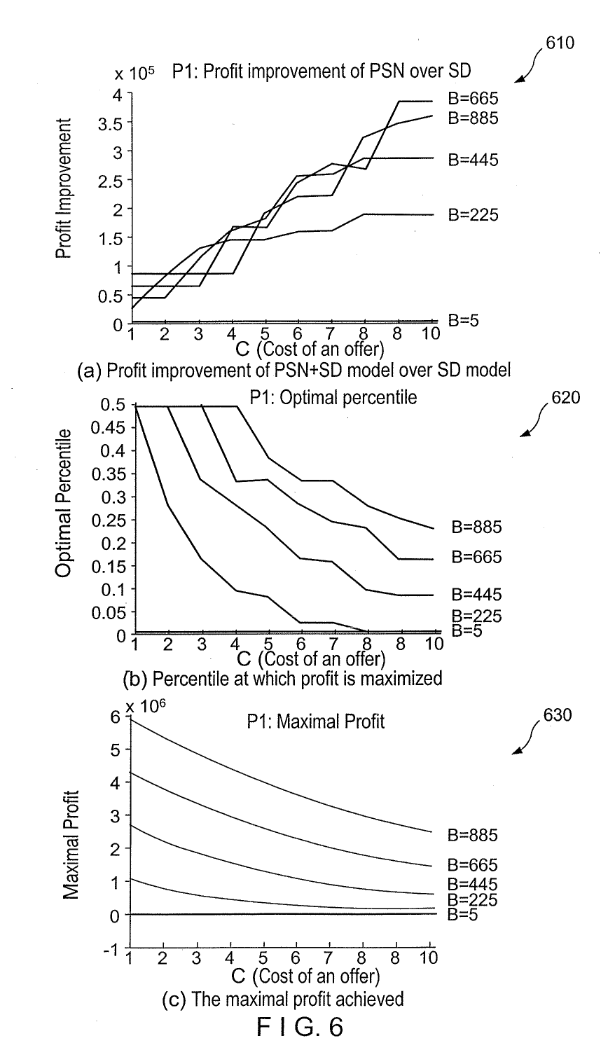

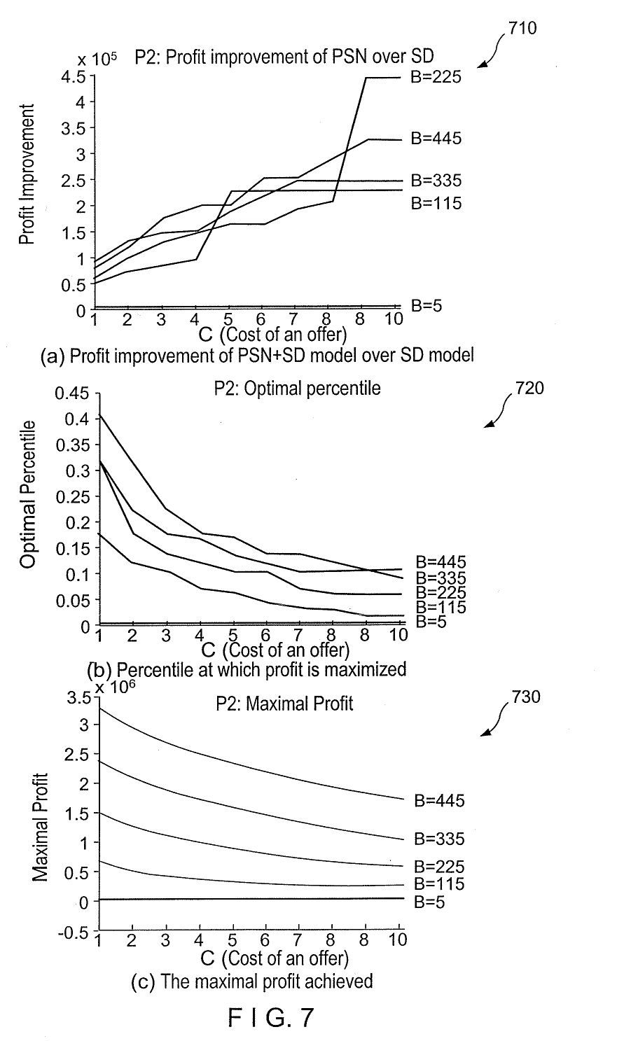

For a single exemplary bank (number of customers fixed), the expected profit can depend on T, the lift curve, and the estimated parameters B and C. For niche products with few customers (lower T), the optimal profit can be obtained at low percentiles, and the profit improvements can be large. Similarly, as the cost per offer goes up (for example, if marketing design costs and time needed by bank managers to talk to responding customers were included), or the benefit per accepted offer goes down, the optimal profit can be obtained by addressing fewer customers, hence at the lower percentiles where the additional profit can be larger. In graphs of FIGS. 6(a)-6(c) and 7(a)-7(c), the results over several estimates of benefits and costs, limited by a reasonable range of values, which can be defined by the lower and upper bounds calculated previously. For example, FIG. 6(a) shows a graph 610 of the exemplary profit improvement of the exemplary PSN+SD approach over the SD model for product 1, FIG. 6(b) shows a graph 620 of the optimal percentile, and FIG. 6(c) shows a graph 630 of the maximum profit over a range of benefits (e.g., B, five lines) and cost for an offer (e.g., C, on the x-axis). FIGS. 7(a)-(c) show graphs 710-730, respectively, of the same information as shown in FIGS. 6(a)-(c) for product 2.

The exemplary extra profit achieved by using the PSN+SD model can be close to about 400.000 [symbol] for a campaign of single product.

### Exemplary Privacy-Friendly Embodiment

According to certain exemplary embodiments of the present disclosure described herein, information on customer characteristics are typically not required. Rather, for example, what can be used can include:
1. An exemplary anonymized transaction exemplary log, which can be a list of exemplary anonymized payment transactions, denoting for each transaction the following exemplary attributes:
   a. Exemplary payment originator (anonymized);
   b. Exemplary payment receiver (anonymized);
   c. Exemplary timestamp; and
   d. Exemplary amount.
2. Exemplary target values for a set of exemplary customers, based on which the exemplary target value for the other customer(s) can be inferred.

The exemplary customer (as well as exemplary entities outside the customer base to and/or from which can be done) can be identified, for example, by random numbers without a name or account number. This exemplary embodiment of privacy friendliness can be an attractive feature in an exemplary banking setting as it can provide for analysts to view customers' names and payment profiles.

Additional exemplary data on exemplary customer characteristics, exemplary payment receiver characteristics and/or exemplary specific transaction details (e.g., comments in a wire transfer, text which can be mined, etc.) can add to the predictive performance, although this can come at a cost for privacy, for example.

### Utilization of Further Exemplary Embodiments

The use of networked data for marketing purposes has been proposed recently. Data can be from online sources (see, e.g., Provost et al., supra.; Macskassy and Provost, supra; Richardson, M., Domingos, P., Mining knowledge-sharing sites for viral marketing, In: KDD '02: Proceedings of the eighth ACM SIGKDD international conference on Knowledge discovery and data mining. ACM, New York, N.Y., USA, pp. 61-70, 2002) or from (offline) telecom logs (see, e.g., Dasgupta et al., supra.; Doyle, S., Social network analysis in the telco sector—marketing applications, Database Marketing & Customer Strategy Management 15 (2), 130-“U134, 2008; Hill Publication, supra). Exemplary embodiments according to the present disclosure can use data that can be a lot richer than used in other approaches where, e.g., connections in the initial graph can be made with entities of one specific type: e.g., products within a certain category (collaborative filtering), other customers (online social network data, telecom) or UGC sites (brand advertising), for example. Accordingly, it is possible to have data on, e.g., sales over many different products and services, bought at several locations and in different amounts, as well as data on payment receipts, for example. In the past, it was believed that there has been no specific network data methodology and/or system for the banking setting such as that disclosed and described herein.

Exemplary embodiments of the present disclosure can provide procedures to obtain pseudo-social network (PSN) data from money transfer data. Although exemplary embodiments have been described with respect to a marketing application, exemplary embodiments of the present disclosure can also be implemented and/or utilized, for example, for assessing the creditworthiness of customers, both in probability of default (PD), loss given default (LGD) as in exposure at default (EAD), e.g., the three risk parameters for regulatory capital requirement calculations in the international Base1 II framework for lending institutions. Further, although exemplary embodiments have been described with respect to retail banking in this document, though the same methodology can be applied for other asset types, such as corporates.

The use of the exemplary PSN methodology on an exemplary real-life payment dataset shows that large improvements can be obtained for the two included financial products. The combination of socio-demographic data with the exemplary PSN score can outperform the socio-demographic model over the complete range of percentiles, with gains observed, for example, in lift at the lower percentiles. Further, the exemplary procedure can be scalable, typically requiring less than an hour to score the customers for a single product even on a desktop PC. The optimal profits can be calculated based on the estimated benefit and cost per offer. Based on the estimated (and verified) parameters, an additional profit of the combined model over the traditional, socio-demographic model can be, for example, around 150.000 [symbol] for a marketing campaign of a single product. When varying the parameters of cost and benefit within a reasonable range, the extra profits can be close to half a million. Larger improvements can be expected, for example, if the optimal percentile is lower, which would be chosen for more niche products (e.g., less customers that bought the product previously), when the benefit is lower or when the cost is higher. The use of the exemplary procedures for the products of a bank an yield large additional profits. Considering also the use for other applications, like churn prediction, much potential exist for the exemplary procedures in a banking setting.

Techniques for collective inference (described in Macskassy and Provost, 2007) may be able to improve additionally over these non-collective techniques.

The bank setting can facilitate a focus on another specific marketing issue within the credit card setting, e.g., share of wallet. The total spent on credit cards can be approximated as the sum of the limits of all credit lines. Taking into account the credit line at the bank itself, share of wallet can be calculated and hence predicted.

The results of previous use of network data can show the potential benefit for marketing applications. Network inference can also be used in a banking setting, where banks do not need to obtain or buy the data externally, which could lead to considerable privacy problems, especially considering the current deliberations of the FTC. The exemplary PSN methodology facilitates a privacy-friendly use of payment transaction data to build predictive data mining models

Exemplary embodiments of methods, computer-accessible medium and systems for obtaining pseudo-social network (PSN) data from exemplary transactional payment data according to the present disclosure can be applicable in the context of, e.g., wire transfers (e.g., exemplary European model) and credit card payments (e.g., exemplary American models). According to certain exemplary embodiments of the present disclosure, inference over the PSN can facilitate applications in, e.g., both marketing and credit risk management. The results of previous exemplary use of network data can show the potential benefit for, e.g., marketing applications. For example, a recent survey by KDD nuggets among data mining specialists showed the following what can be considered to be the top four industries where data mining was applied in 2009:

1. CRM/consumer analytics: 32.8%;

2. Banking 24.4%;

3. Direct Marketing/Fundraising 16.1%; and

4. Credit Scoring 15.6%.

Certain exemplary embodiments of the present disclosure can therefore be considered to be applicable to these top four application areas of data mining. Based on the relatively large size of the banking industry (e.g., the U.S. banking sector's short-term liabilities as of Oct. 11, 2008 can be considered as consisting of approximately 15% of the GDP of the United States (Norris, 2008)), the application potential for certain exemplary embodiments in accordance with the present disclosure can be vast.

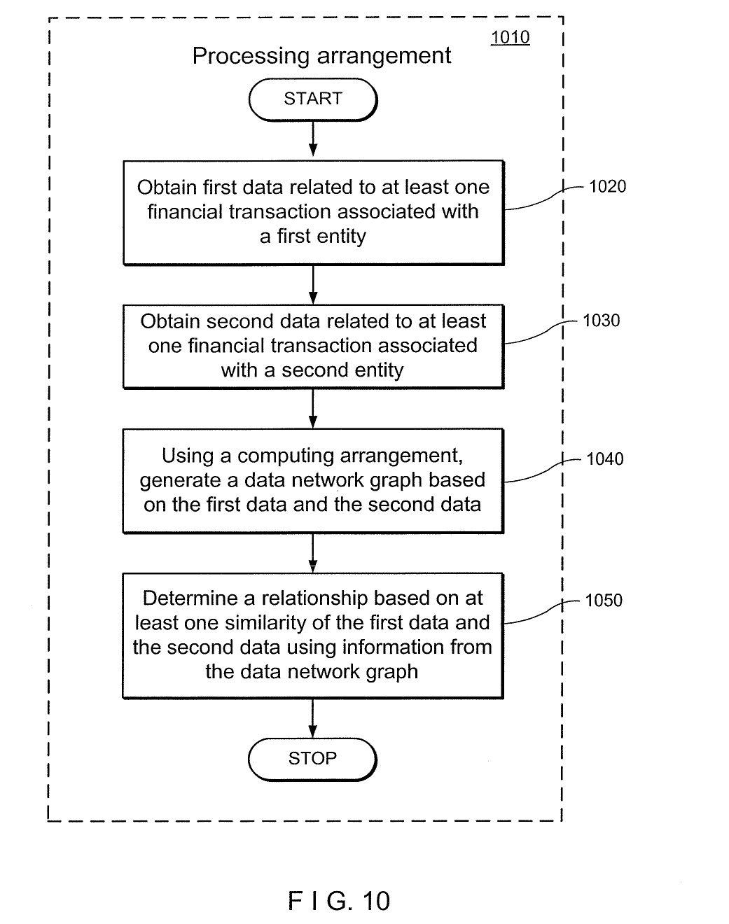

FIG. 10 is a flow diagram according to exemplary embodiments of the present disclosure. As shown in FIG. 10, for example, data can be obtained relating to a financial transaction associated with a first entity (1020). Next, additional data can be obtained relating to a transaction associated with a second entity (1030). After the data has been obtained, a computing arrangement can be used to generate a data network graph based on the obtained data (1040). Using this graph, a relationship can be determined based on similarities between the obtained data.

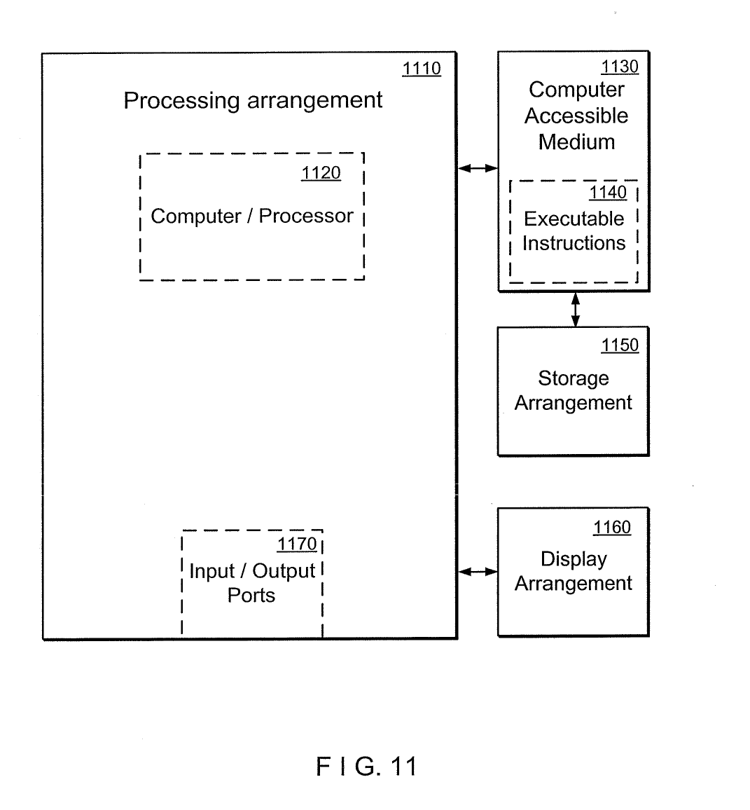

FIG. 11 shows an exemplary block diagram of an exemplary embodiment of a system according to the present disclosure. For example, the exemplary tool and/or procedures in accordance with the present disclosure described herein can be performed by a processing arrangement and/or a computing arrangement 1110. Such processing/computing arrangement 1110 can be, e.g., entirely or a part of, or include, but not limited to, a computer/processor 1120 that can include, e.g., one or more microprocessors, and use instructions stored on a computer-accessible medium (e.g., RAM, ROM, hard drive, or other storage device).

As shown in FIG. 11, e.g., a computer-accessible medium 1130 (e.g., as described herein above, a storage device such as a hard disk, floppy disk, memory stick, CD-ROM, RAM, ROM, etc., or a collection thereof) can be provided (e.g., in communication with the processing arrangement 1110). The computer-accessible medium 1130 can contain executable instructions 1140 thereon. In addition or alternatively, a storage arrangement 1150 can be provided separately from the computer-accessible medium 1130, which can provide the instructions to the processing arrangement 1110 so as to configure the processing arrangement to execute certain exemplary procedures, processes and methods, as described herein above, for example.

Further, the exemplary processing arrangement 1110 can be provided with or include an input/output arrangement 1170, which can include, e.g., a wired network, a wireless network, the Internet, an intranet, a data collection probe, a sensor, etc. As shown in FIG. 11, the exemplary processing arrangement 1110 can be in communication with an exemplary display arrangement 1160, which, according to certain exemplary embodiments of the present disclosure, can be a touch-screen configured for inputting information to the processing arrangement in addition to outputting information from the processing arrangement, for example. Further, the exemplary display 1160 and/or a storage arrangement 1150 can be used to display and/or store data in a user-accessible format and/or user-readable format.

The foregoing merely illustrates the principles of the present invention. Various modifications and alterations to the described exemplary embodiments will be apparent to those having ordinary skill in the art in view of the teachings disclosed and described herein. It will thus be appreciated that those having ordinary skill in the art will be able to devise numerous systems, arrangements, and methods which, although not explicitly shown or described herein, embody the principles of the present invention and are thus within the spirit and scope of the present invention. In addition, all publications and references referred to herein are hereby incorporated herein by reference in their entireties. It should be understood that the exemplary methods and/or procedures disclosed and described herein can be stored on any computer accessible medium, including, e.g., a hard drive, RAM, ROM, removable discs, CD-ROM, memory sticks, etc., included in, e.g., a stationary, mobile, cloud or virtual type of system, and executed by, e.g., a computing arrangement and/or hardware processing arrangement which can be and/or include, e.g., a microprocessor, mini, macro, mainframe, etc.

1. A process for generating privacy-friendly pseudo-social networked (PSN) data from off-line banking data, comprising:
obtaining first data related to at least one financial transaction associated with a first entity;
obtaining second data related to at least one financial transaction associated with a second entity;
using a computing arrangement, generating a data network graph based on the first data and the second data; and
determining a relationship based on at least one similarity of the first data and the second data using information from the data network graph.

2. The process of claim 1, further comprising at least one of displaying or storing information associated with the relationship in a storage arrangement in at least one of a user-accessible format or a user-readable format.

3. A computer-accessible medium containing executable instructions thereon, wherein when at least one computing arrangement executes the instructions, the at least one computing arrangement is configured to perform procedures comprising:
obtaining first data related to at least one financial transaction associated with a first entity;
obtaining second data related to at least one financial transaction associated with a second entity;
generating a data network graph based on the first data and the second data; and
determining a relationship based on at least one similarity of the first data and the second data using information from the data network graph.

4. A system for determining a token causality, comprising:
a computer-accessible medium having executable instructions thereon, wherein when at least one computing arrangement executes the instructions, the at least one computing arrangement is configured to:
obtain first data related to at least one financial transaction associated with a first entity;
obtain second data related to at least one financial transaction associated with a second entity;
generate a data network graph based on the first data and the second data; and
determine a relationship based on at least one similarity of the first data and the second data using information from the data network graph.

5. A method for determining at least one relationship associated with particular data, comprising:
obtaining first data associated with at least one first transaction performed by at least one first entity;
obtaining second data associated with at least one second transaction performed by at least one second entity;
using a computing arrangement, generating a pseudo-social network (PSN) based on at least the first and second data; and
determining the at least one relationship using the PSN.

6. The method of claim 5, wherein the PSN includes an inferred network based on characteristics associated with the first data and the second data.

7. The method of claim 5, wherein the at least on relationship is at least one of (i) determined based on a similarity between the first and second data, (ii) associated with at least one target variable, or (iii) used for at least one of marketing or assessing risk.

8-9. (canceled)

10. The method of claim 5, wherein the at least one relationship includes at least one of (i) at least one output score, or (ii) an associated strength based on at least one link in the PSN.

11. The method of claim 10, wherein the associated strength includes a weighted and an aggregated index of at least one networked entity within the PSN.

12. The method of claim 5, wherein the determination of the at least one relationship using the PSN includes generating at least one weighted score associated with each of the first and second entities.

13. The method of claim 5, wherein each of the at least one respective weighted score includes an aggregation of transactions associated with a respective entity of the first and second entities.

14. The method of claim 13, wherein the at least one weighted score includes at least one of (i) a micro-affinity factor associated with each of the aggregated transactions, or (ii) a negative factor associated with at least one of the aggregated transactions.

15-16. (canceled)

17. The method of claim 5, further comprising combining the PSN with at least one predictive model, and determining the at least one relationship using the combination of the PSN and the predictive model.

18. The method of claim 17, wherein the at least one predictive model includes at least one of a socio-demographic (SD) model, a logistic regression model or a support vector machine (SVM) model.

19. A computer-accessible medium containing executable instructions thereon, wherein when at least one computing arrangement executes the instructions, the at least one computing arrangement is configured to perform procedures comprising:
obtain first data associated with at least one first transaction performed by at least one first entity;
obtain second data associated with at least one second transaction performed by at least one second entity;
generate a pseudo-social network (PSN) based on at least the first and second data; and
determine at least one relationship using the PSN.

20. The computer-accessible medium of claim 19, wherein the PSN includes an inferred network based on characteristics associated with the first and data and the second data.

21. The computer-accessible medium of claim 19, wherein the at least on relationship is at least one of (i) determined based on a similarity between the first and second data, (ii) associated with at least one target variable, or (iii) used for at least one of marketing or assessing risk.

22-23. (canceled)

24. The computer-accessible medium of claim 19, wherein the at least one relationship includes at least one of (i) at least one output score, or (ii) an associated strength based on at least one link in the PSN.

25. The computer-accessible medium of claim 24, wherein the associated strength includes a weighted and aggregated index of at least one networked entity within the PSN.

26. The computer-accessible medium of claim 19, wherein determination of the at least one relationship using the PSN includes generating at least one weighted score associated with each of the first and second entities.

27. The computer-accessible medium of claim 19, wherein each of the at least one respective weighted score includes an aggregation of transactions associated with a respective entity of the first and second entities.

28. The computer-accessible medium of claim 27, wherein the at least one weighted score includes at least one of (i) a micro-affinity factor associated with each of the aggregated transactions, or (ii) a negative factor associated with at least one of the aggregated transactions.

29-30. (canceled)

31. The computer-accessible medium of claim 19, wherein the computing arrangement is further configured to combine the PSN with at least one predictive model, and determine the at least one relationship using the combination of the PSN and the predictive model.

32. The computer-accessible medium of claim 31, wherein the at least one predictive model includes at least one of a socio-demographic model, a logistic regression model or a support vector machine (SVM) model.
